(19) United States
(12) Patent Application Publication
(10) Pub. No.: US 2013/0344788 A1
(43) Pub. Date: Dec. 26, 2013

(54) HVAC SYSTEM ZONE COMPENSATION FOR IMPROVED COMMUNICATION PERFORMANCE

(71) Applicants: Gary M. Buch, Washington, MI (US); Jesse T. Gratke, Royal Oak, MI (US); Nathan D. Ampunan, Novi, MI (US); Douglas C. Martin, Oxford, MI (US); Bassam S. Shahmurad, Clinton Township, MI (US)

(72) Inventors: Gary M. Buch, Washington, MI (US); Jesse T. Gratke, Royal Oak, MI (US); Nathan D. Ampunan, Novi, MI (US); Douglas C. Martin, Oxford, MI (US); Bassam S. Shahmurad, Clinton Township, MI (US)

(73) Assignee: GM GLOBAL TECHNOLOGY OPERATIONS LLC, Detroit, MI (US)

(21) Appl. No.: 13/530,834

(22) Filed: Jun. 22, 2012

(51) Int. Cl. B60H 1/24

(52) U.S. Cl. 454/75

(57) ABSTRACT

A system, method and apparatus to control climate in multiple zones of a passenger cabin of a vehicle are provided. The system includes a control unit having a receiving unit configured to receive signals from a plurality of microphones associated with each zone of the multiple zones. A determining unit is configured to determine an active microphone from the plurality of microphones based on from which microphone a strongest of the signals was received and to determine an active zone as the zone with which the active microphone is associated. The control unit further includes a fan operating unit configured to control a plurality of fans of the climate control system and to reduce a speed of the at least one fan associated with the active zone in response to the signal received from the active microphone.

### FIELD OF THE INVENTION

The subject invention relates to an in-vehicle climate control system responsive to operation of voice related systems of the vehicle.

### BACKGROUND

A vehicle may include various voice related systems, for example, voice activated control systems or hands free telephone systems. These systems include a microphone, or a series of microphones, placed within a passenger cabin of the vehicle. The microphones are configured to capture a passenger's voice.

A vehicle may also include a HVAC system, such as a vehicle climate control system. In vehicle climate control systems, a passenger may set a desired temperature for the passenger cabin, or alternatively, operate the climate control system until a desired temperature within the passenger cabin is reached. The climate control system includes at least one fan to circulate air into the passenger cabin.

Further, some vehicles may include multi-zone climate control systems. In these systems, passengers may operate the climate control system to adjust the temperature in a particular passenger zone of the vehicle. Here, the climate control system may include one or more fans positioned in each passenger zone. The fans are configured to circulate air to the respective passenger zones in which the fans are located.

One drawback of the climate control systems is that the fan or fans may create an undesirable level of noise. Thus, when the fan or fans operate while the voice related system is being used, there may be an unsuitable level of background noise. The background noise from the fans of the climate control system may interfere with the microphones of voice related systems.

To address this issue, some vehicles control the climate control systems such that all of the fans are turned down, or off, when a voice related system is in use. However, this may adversely affect the comfort of the passengers in the vehicle cabin because the climate of the passenger cabin may not be effectively controlled when the fans are turned down or off.

Accordingly, it is desirable to provide a multi-zone climate system that does not substantially interfere with a voice related system while maintaining a desired climate in the vehicle.

### SUMMARY OF THE INVENTION

In one exemplary embodiment of the invention there is provided a multi-zone climate control system for a vehicle configured to supply air to multiple zones of a passenger cabin of the vehicle. The system includes at least one fan associated with each of the multiple zones and configured to supply air to the zone with which the at least one fan is associated. The system further includes a control unit having a receiving unit configured to receive signals from a plurality of microphones, at least one microphone associated with each zone of the multiple zones and a determining unit configured to determine an active microphone from the plurality of microphones based on from which microphone a strongest of signals is received. The determining unit is also configured to determine an active zone of the multiple zones as the zone with which the active microphone is associated. The control unit further includes a fan operating unit configured to control the fans of the climate control system. The fan operating unit is further configured to reduce a speed of the at least one fan associated with the active zone in response to the signal received from the active microphone.

In another exemplary embodiment of the invention, there is provided a method of controlling a climate control system to control climate in multiple zones of a passenger cabin of a vehicle, wherein at least one fan is associated with each zone to supply air thereto. The method includes operating at least one fan associated with at least one respective zone to supply air to the at least one respective zone, receiving a signal from at least one microphone positioned in at least one zone of the multiple zones, and determining an active microphone from the at least one microphone as a microphone from which a strongest signal is received. The method further includes determining a zone with which the active microphone is associated as an active zone and controlling a speed of at least one fan associated with the active zone in response to the signal received from the active microphone.

In yet another exemplary embodiment of the invention, there is provided an apparatus for controlling a climate control device to supply air to multiple zones of a vehicle. The apparatus includes a receiving unit configured to receive signals from a plurality of microphones, at least one microphone associated with each zone of the multiple zones and a determining unit configured to determine an active microphone from the plurality of microphones based on from which microphone a strongest of the signals was received. The determining unit is also configured to determine an active zone of the multiple zones as the zone with which the active microphone is associated. The apparatus further includes a fan operating unit configured to control a plurality of fans of the climate control system, with at least one fan associated with each respective zone of the multiple zones. The fan operating unit is further configured to reduce a speed of the at least one fan associated with the active zone in response to the signal received from the active microphone.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a diagram showing a multi-zone arrangement in a vehicle;

FIG. 2 is a diagram showing a vehicle with a voice related system and multi-zone climate control system;

FIG. 3 is a schematic diagram showing a relationship between the voice related system and climate control system;

FIG. 4 is a diagram showing a control unit according to an exemplary embodiment of the subject invention;

FIG. 5 is a diagram showing a method of controlling a climate control system according to an exemplary embodiment of the subject invention; and

FIG. 6 is a diagram showing the climate control system in operation according to an exemplary embodiment of the subject invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

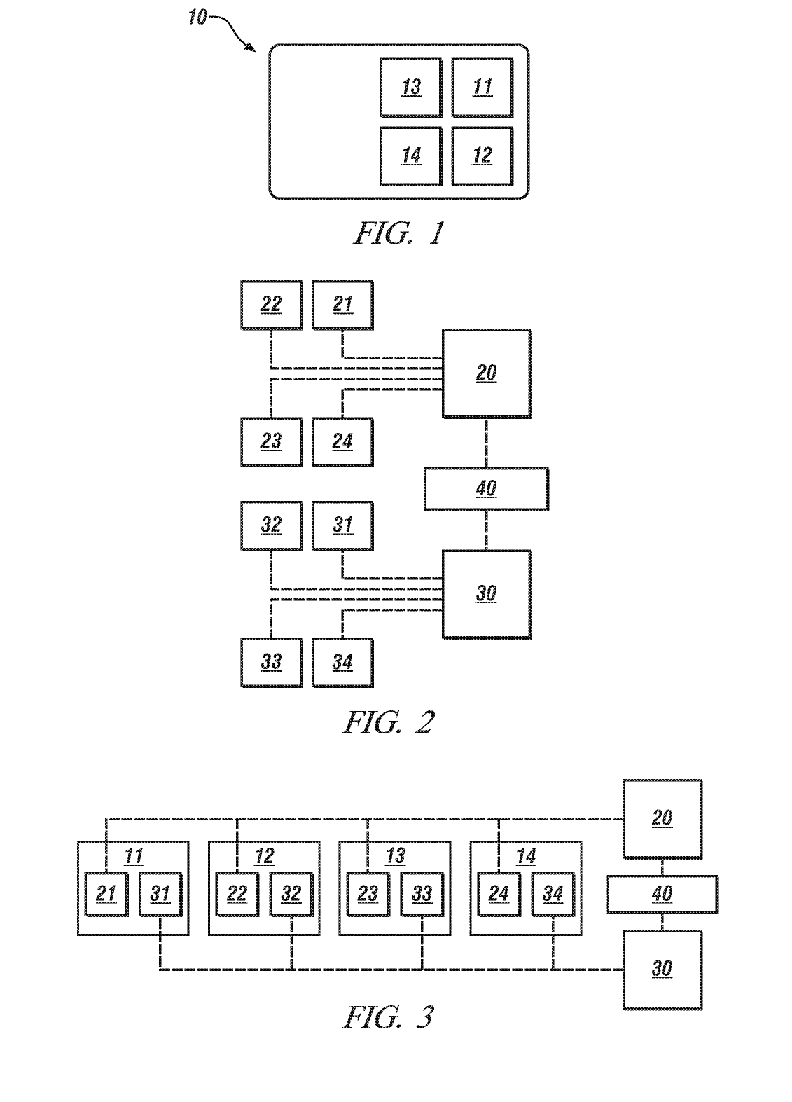

With reference to FIG. 1, a passenger of cabin of a vehicle 10 may be organized into multiple zones. In an exemplary embodiment, the passenger cabin may include four zones 11, 12, 13, 14. It is understood, however, that this example is non-limiting and that the passenger cabin may include fewer or more zones.

With reference to FIGS. 2 and 3, the vehicle 10 may also include a voice related system 20. The voice related system 20 may be, for example, a voice recognition system used to control or operate various systems of the vehicle, or a hands free telephone or other communication system. The voice related system 20 includes at least one microphone 21, 22, 23, 24 configured to convert a sound from a passenger's voice to an electrical signal.

With further reference to FIGS. 2 and 3, in an exemplary embodiment, the voice related system 20 includes a plurality of microphones 21, 22, 23, 24. At least one microphone of the plurality of microphones is positioned in, or otherwise associated with, each zone 11, 12, 13, 14. In the exemplary embodiment illustrated in FIG. 3, there are four zones 11, 12, 13, 14 in the vehicle, and one microphone 21, 22, 23, 24 positioned in each zone, respectively. However, it is understood that more than one microphone may be positioned in each zone 11, 12, 13, 14. Further, in other exemplary embodiments, a microphone may not be positioned in a particular zone but may still be configured to convert sound from a passenger's voice from the particular zone into an electrical signal based on the proximity of the microphone to the particular zone.

An HVAC system, such as climate control system 30, may also be installed in the vehicle 10, as shown in FIGS. 2 and 3. The climate control system 30 may be operated by a passenger of the vehicle 10 to control the temperature within the passenger cabin of the vehicle. The climate control system 30 controls the temperature within the passenger cabin by supplying conditioned air, e.g., heated or cooled air, to the passenger cabin. In an exemplary embodiment, the climate control system 30 is a multi-zone climate control system. In a multi-zone climate control system, air may be supplied directly to the zones 11, 12, 13, 14 by fans 31, 32, 33, 34 positioned in or associated with each zone 11, 12, 13, 14.

With reference to the exemplary embodiment in FIGS. 1-3, the multi-zone climate control system 30 is a quad-zone climate control system. In a quad-zone climate control system, air may be supplied to each zone 11, 12, 13, 14 via the fans 21, 22, 23, 24 positioned in the respective zones to control the temperature, or climate, of the vehicle cabin.

In addition, the temperature, or climate, of the four zones 11, 12, 13, 14 in the passenger cabin may be individually controlled. For example, the quad-zone climate control system 30 may be operated by a first passenger to control the climate in first zone 11, while the quad-zone climate control system 30 may be operated by a second passenger to control the climate in the second zone 12. Alternatively, the quad-zone climate control system 30 may be operated such that the fans 31, 32, 33, 34 are configured to supply air to the passenger cabin to control the temperature of the passenger cabin as whole. It is understood that the multi-zone climate control system may include more than one fan associated with each zone 11, 12, 13, 14 of the passenger cabin.

The fan or fans associated with each zone 11, 12, 13, 14 operate to supply air to a respective zone based on a passenger's operation of the quad-zone climate control system 30. For example, the first passenger in the first zone 11 may operate the quad-zone climate control system 30 by setting a desired temperature for the first zone 11. In response, the quad-zone climate control 30 system supplies air via the first fan or fans 31 associated with the first zone 11. The supplied air may be conditioned, e.g., heated or cooled, to change the temperature within the first zone 11 to the desired temperature set by the first passenger. The fan or fans associated with the second, third and fourth passenger zones 12, 13, 14 may be controlled in a similar manner.

The fans 31, 32, 33, 34 may operate at different speeds to vary the volume air supplied to a zone 11, 12, 13, 14. For example, where a larger volume of air is required to more quickly change the temperature in a zone, the fan or fans associated with that zone may operate at a higher speed. Generally, more noise is produced by a fan when operating at a high speed.

It is understood that the climate control system 30 of the subject invention is not limited to the quad-zone climate control system described above. The climate control system 30 may be any single or multi-zone climate control system configured to control the climate, either collectively or individually, in as many zones as there may be provided in the vehicle. For example, a dual-zone or tri-zone climate control system may be provided where a passenger cabin of the vehicle includes two or three zones, respectively. Further, a multi-zone climate control system may be used to control the climate in multiple zones, either collectively or individually, where a passenger cabin of the vehicle includes more than four zones. In the above examples, the climate control system includes a fan or fans associated with the respective zones that supply air thereto to control the climate of the zone.

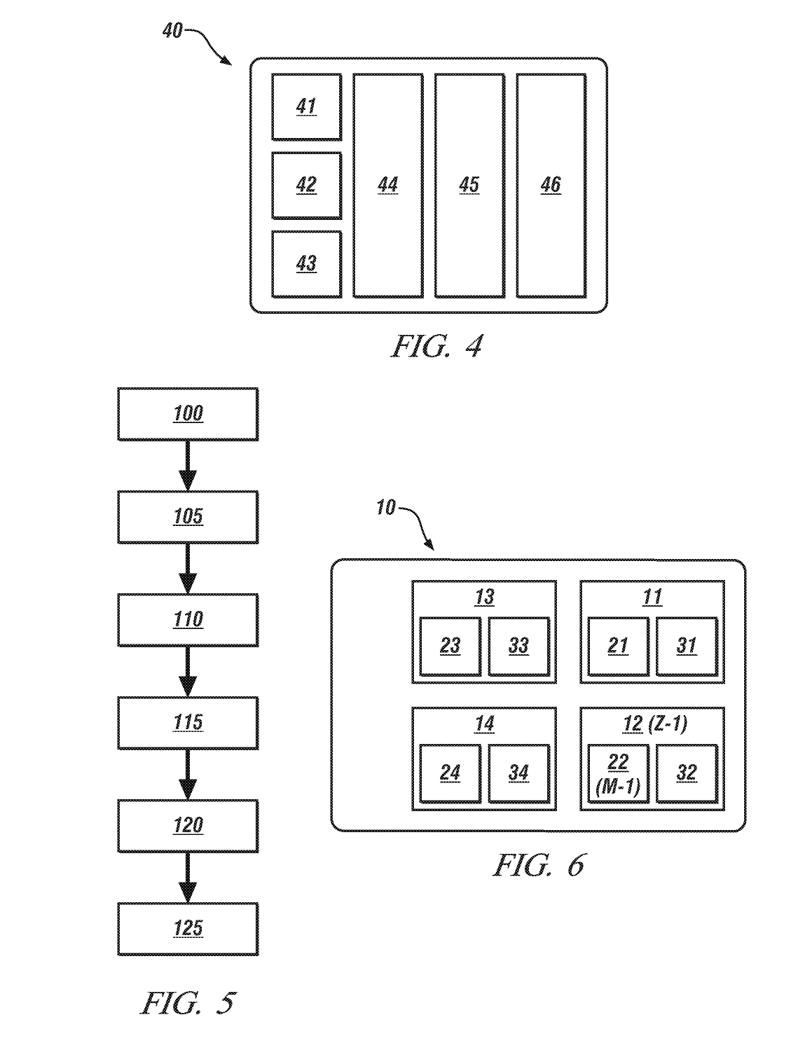

Referring to FIG. 4, the climate control system 30 is controlled by a control unit 40. The control unit 40 includes, for example, a microprocessor 41, a memory storage unit 42 and an input/output (I/O) module 43. The memory storage unit 42 is configured to store program instructions which may be executed by the microprocessor 41. The memory storage unit may further store data that is input through the I/O module 43.

The control unit 40 may selectively control the operation of the fans 31, 32, 33, 34 based on input from at least one passenger of the vehicle 10. For example, the control unit 40 may selectively operate a fan 31 when a passenger in zone 11 inputs a desired temperature that differs from a current temperature of zone 11.

With further reference to FIG. 4, the control unit 40 further includes a receiving unit 44, a determining unit 45 and a fan operating unit 46. The receiving unit 44 is configured to receive electrical signals from an external source. For example, the receiving unit may receive electrical signals generated by the microphones 21, 22, 23, 24 of the voice related system 20.

The determining unit 45 is configured to determine a strongest signal of the received signals. For example, the receiving unit 44 may receive a plurality of signals from the microphones 21, 22, 23, 24. The determining unit 45 may determine which microphone 21, 22, 23, 24 is producing the strongest signal and designates the microphone 21, 22, 23, 24 producing the strongest signal as an active microphone M-1. The determining unit 45 identifies which microphone 21, 22, 23, 24 is producing the strongest signal, for example, by comparing average amplitudes of the received signals. The active microphone is the microphone positioned relative to a passenger in such a way to produce the strongest signal when that passenger is speaking.

In addition, because the microphones 21, 22, 23, 24 are associated with respective zones 11, 12, 13, 14, the determining unit 45 may then designate an active zone Z-1 based on the determination of the active microphone M-1. In an exemplary embodiment, the active zone Z-1 is the zone 11, 12, 13, 14 where a passenger using the active microphone M-1 is positioned. The determining unit 45 outputs the active microphone M-1 and active zone Z-1 to the fan operating unit 46.

The fan operating unit 46 is configured to control operation of the fans 31, 32, 33, 34 based on the output from the determining unit 45. That is, the fan operating unit 46 is configured to control the fans 31, 32, 33, 34 based on the active zone Z-1 determined by the determining unit 45. In an exemplary embodiment, the fan operating unit 46 controls the fan or fans associated with the active zone Z-1 to reduce the speed of the fan or fans, or turn the fan off entirely.

The fan operating unit 46 may be further configured to control the fans associated with the zones other than the active zone Z-1. For example, to compensate for the reduced speed of the fan or fans associated with the active zone, the fan operating unit 46 may increase the speed of at least one of the fans associated with any of the zones other than the active zone. Accordingly, a desired climate may be maintained in the passenger cabin despite the reduced speed of fan or fans associated with the active zone.

It is understood that the control unit 40 may be implemented as part of the climate control system 30, or separately therefrom. In an embodiment where there control unit 40 is implemented separately from the climate control system 30, the control unit 40 is operably and communicably connected to the climate control system 30 and the fans 31, 32, 33, 24 so that the control unit 40 may control operations performed by the climate control system 30.

With reference to FIG. 5, the control unit 40 controls the climate control system 30 according to the following exemplary method. It is understood that the following method is described for the purposes of example only and is non-limiting.

At 100, the control unit 40 operates at least one fan associated with at least one respective zone to supply air to the at least one respective zone. At 105, the receiving unit 44 of the control unit 40 receives at least one signal from an external source, such as a microphone 21, 22, 23, 24. The microphone 21, 22, 23, 24 may generate the signal in response a sound generated by a passenger's voice in a vehicle cabin when the voice related system 20 is in use. In some instances, more than one microphone may generate a signal in response to the sound generated by the passenger's voice.

The determining unit 45 determines which signal received by the receiving unit 44 is strongest. In an exemplary embodiment, the determining unit may do so by detecting which signal has the largest average amplitude. This signal is considered to come from the microphone 21, 22, 23, 24 positioned nearest to the speaking passenger. Other microphones positioned throughout the passenger cabin may also generate a signal in response to the sound generated by the passenger's voice. However, due to the position of the other microphones, the generated signals will have lower average amplitudes. At 110, the determining unit 45 then determines the microphone which generates the strongest signal as the active microphone M-1.

In addition, as detailed above, at least one microphone 21, 22, 23, 24 is associated with each zone 11, 12, 13, 14. The control unit 40 stores the association between the microphones 21, 22, 23, 24 and the respective zones 11, 12, 13, 14. Thus, with reference FIG. 5, by determining the active microphone M-1 at 110, the determining unit 45 also determines an active zone Z-1 at 115. The active zone Z-1 is the zone with which the active microphone M-1 is associated.

For example, with reference to FIG. 6, a passenger positioned in zone 12 of the vehicle may be using the voice related system 20. In this example, the microphone 22 of the voice related system 20 is associated with zone 12 of the vehicle. The microphone 22 generates a signal in response to the sound from the passenger's voice. The signal is received by the receiving unit 44 of the control unit 40, and the determining unit 45 determines that the signal is received from the microphone 22 associated with zone 12. Accordingly, the determining unit 45 designates microphone 22 and zone 12 as the active microphone M-1 and active zone Z-1, respectively. The determining unit 45 then outputs the active microphone M-1 and active zone Z-1 to the fan operating unit 46.

With reference to FIG. 5, the method further includes the fan operating unit 46 controlling the fans 31, 32, 33, 34 of the climate control system 30 based on at least on the active zone Z-1 determined by the determining unit 45. As detailed above, at least one fan 31, 32, 33, 34 is associated with each zone 11, 12, 13, 14. This information is stored at the control unit 40 and accessible by the fan operating unit 46. Thus, at 120 the fan operating unit 46 may control the speed of the fan associated with the active zone Z-1. In an exemplary embodiment, the fan operating unit 46 reduces the speed of the fan or fans associated with the active zone Z-1 to reduce background noise caused by the fan in that zone. Further, at 125, the fan operating unit 46 may control at least one fan associated with at least one zone other than the active to compensate for the reduced speed of the fan or fans associated with the active zone Z-1.

For example, in accordance with an exemplary embodiment of the subject invention, and with reference to FIG. 6, fan 22 is associated with the zone 12. In the example discussed above, and shown in FIG. 5, zone 12 is determined to be the active zone Z-1. Thus, the fan operating unit 46 reduces the speed of fan 22 in zone 12, or stops the fan 22 altogether, thereby reducing noise caused from operation of the fan 22.

Further, the fan operating unit 46 may operate at least one of the other fans, 21, 23, 24, associated with zones 11, 12, 13, 14 other than the active zone Z-1, to compensate for the reduced speed of the fan 22 associated with the active zone Z-1. For example, the fan operating unit 46 may increase the speed of at least one of the fans 21, 23, 24 in zones 11, 13, 14 to provide a higher volume of conditioned air to the vehicle cabin. Thus, the climate of the vehicle cabin may be maintained despite the reduced speed of the fan or fans associated with the active zone Z-1.

Accordingly, the components, systems and methods described above may reduce background noise captured by a microphone of a voice related system in a vehicle by reducing the fan speed of a fan positioned in the same zone as the microphone. Further, effects on the temperature or climate within the vehicle cabin caused by the reduced fan speed may be compensated for by the other fans. That is, the speed of at least one of the other fans, positioned in, or associated with, a zone where microphones are not in use, may be increased to compensate for the reduced-speed fan.

While the invention has been described with reference to the exemplary embodiments, it will be understood by those skilled in the art that various changes may be made and equivalents may be substituted for elements thereof without departing from the scope of invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A multi-zone climate control system for a vehicle, the multi-zone climate control system configured to control climate in multiple zones of a passenger cabin of a vehicle, the system comprising:
at least one fan associated with each of the multiple zones and configured to supply air to the zone with which the at least one fan is associated, and
a control unit comprising:
a receiving unit configured to receive signals from a plurality of microphones, at least one microphone associated with each zone of the multiple zones;
a determining unit configured to determine an active microphone from the plurality of microphones based on from which microphone a strongest of signals is received and to determine an active zone of the multiple zones as the zone with which the active microphone is associated; and
a fan operating unit configured to control the fans of the climate control system, the fan operating unit further configured to reduce a speed of at least one fan associated with the active zone in response to the signal received from the active microphone.

2. The multi-zone climate control system of claim 1, wherein the fan operating unit is configured to increase a speed of at least one fan associated with a zone other than the active zone to compensate for the reduced speed of the at least one fan associated with the active zone.

3. The multi-zone climate control system of claim 1, wherein the multi-zone climate control system supplies air to four zones in a vehicle.

4. The multi-zone climate control system of claim 1, wherein the fans associated with each zone are individually controlled so as to control the climate in each zone.

5. A method of controlling a climate control system to control climate in multiple zones of a passenger cabin of a vehicle, wherein at least one fan is associated with each zone to supply air thereto, the method comprising:
operating at least one fan associated with at least one respective zone to supply air to the at least one respective zone;
receiving a signal from at least one microphone positioned in at least one zone of the multiple zones;
determining an active microphone from the at least one microphone as a microphone from which a strongest signal is received;
determining a zone with which the active microphone is associated as an active zone; and
controlling a speed of at least one fan associated with the active zone in response to the signal received from the active microphone.

6. The method of claim 5, wherein controlling the speed of the at least one fan associated with the active zone comprises reducing the speed of the at least one fan associated with the active zone.

7. The method of claim 6, further comprising operating at least one fan associated with at least one zone other than the active zone to compensate for the reduced speed of the at least one fan associated with the active zone.

8. The method of claim 5, wherein there are four zones of the passenger cabin of the vehicle.

9. An apparatus for controlling a climate control device to control climate in multiple zones of a passenger cabin of a vehicle, the apparatus comprising:
a receiving unit configured to receive signals from a plurality of microphones, at least one microphone associated with each zone of the multiple zones;
a determining unit configured to determine an active microphone from the plurality of microphones based on from which microphone a strongest of the signals was received and determine an active zone of the multiple zones as the zone with which the active microphone is associated; and
a fan operating unit configured to control a plurality of fans of the climate control system, at least one fan associated with each respective zone of the multiple zones, the fan operating unit further configured to reduce a speed of the at least one fan associated with the active zone in response to the signal received from the active microphone.

10. The apparatus of claim 9, where the apparatus is further configured to adjust a speed of the at least one fan in at least one of the multiple zones other than the active zone.

11. The apparatus of claim 9, wherein the apparatus controls a climate control device to supply air to four zones of a vehicle.

12. The apparatus of claim 9, wherein the fan control unit is further configured to individually control the fans associated with each zone so as to control the climate in each zone.
